(19) United States
(12) Patent Application Publication
(10) Pub. No.: US 2025/0110528 A1
(43) Pub. Date: Apr. 3, 2025

(54) ELECTRONIC DEVICE

(71) Applicant: Lenovo (Beijing) Limited, Beijing (CN)

(72) Inventor: Like ZHONG, Beijing (CN)

(21) Appl. No.: 18/882,737

(22) Filed: Sep. 11, 2024

(30) Foreign Application Priority Data
Sep. 28, 2023 (CN) 202311272537.9

(51) Int. Cl. G06F 1/16; G06F 3/14

(52) U.S. Cl. CPC G06F 1/1624; G06F 1/1618; G06F 1/1677; G06F 3/1431

(57) ABSTRACT

An electronic device includes a first body, a second body, and a display assembly. The first body includes a first area and a second area, the first area being an input area. The second body rotates relative to the first body. An end of the display assembly is fixedly connected to an end of the second body away from the first body. A display area of the display assembly includes a first display area arranged inside the first body and is visible to a user through the second area.

### CROSS-REFERENCE TO RELATED APPLICATION

The present disclosure claims priority to Chinese Patent Application No. 202311272537.9, filed on Sep. 28, 2023, the entire content of which is incorporated herein by reference.

### TECHNICAL FIELD

The present disclosure relates to the electronic technology field and, more particularly, to an electronic device.

### BACKGROUND

As electronic technology advances, laptop computers are widely used and has become an essential interactive tool. However, a display screen is an important member of a laptop computer and only has a display area on surface B (surface A being the top cover of the laptop, surface C being the top surface of the bottom body, surface D being the bottom cover of the laptop) of the laptop computer. Thus, the application method for the display screen is limited.

### SUMMARY

The present disclosure provides an electronic device, including a first body, a second body, and a display assembly. The first body includes a first area and a second area, the first area being an input area. The second body rotates relative to the first body. An end of the display assembly is fixedly connected to an end of the second body away from the first body. A display area of the display assembly includes a first display area arranged inside the first body and is visible to a user through the second area.

### BRIEF DESCRIPTION OF THE DRAWINGS

FIG. 1 illustrates a schematic structural diagram of an electronic device according to some embodiments of the present disclosure.

FIG. 2 illustrates a schematic local cross-section of an electronic device according to some embodiments of the present disclosure.

FIG. 3 illustrates another schematic local cross-section of an electronic device according to some embodiments of the present disclosure.

FIG. 4 illustrates another schematic local cross-section of an electronic device according to some embodiments of the present disclosure.

FIG. 5 illustrates a schematic diagram of surface C of an electronic device according to some embodiments of the present disclosure.

FIG. 6 illustrates a schematic local diagram of surface C of an electronic device according to some embodiments of the present disclosure.

FIG. 7 illustrates a schematic diagram showing a display assembly sliding out in an electronic device according to some embodiments of the present disclosure.

FIG. 8 illustrates a schematic diagram showing a display assembly sliding in in an electronic device according to some embodiments of the present disclosure.

### DETAILED DESCRIPTION OF THE EMBODIMENTS

Embodiments of the present disclosure are described in detail in connection with the accompanying drawings of embodiments of the present disclosure. Described embodiments are merely some embodiments of the present disclosure, not all embodiments of the present disclosure. Based on embodiments of the present disclosure, all other embodiments obtained by those skilled in the art without creative efforts are within the scope of the present disclosure.

Various modifications and changes can be made without departing from the spirit or scope of the present disclosure, which is obvious to those skilled in the art. Therefore, the present disclosure is intended to cover the modifications and changes of the present disclosure that fall within the scope of the corresponding claims (the claimed technical solutions) and equivalents of the claims. Implementations of embodiments of the present disclosure can be combined when there is no contradiction.

To make the above purposes, features, and advantages of the present disclosure clear and understandable, the present disclosure is further described in detail in conjunction with the accompanying drawings and embodiments of the present disclosure.

As described in the background, the display screen, as an important member of a laptop computer, only has a display area on surface B side of the laptop computer. Thus, the application method of the display screen is limited.

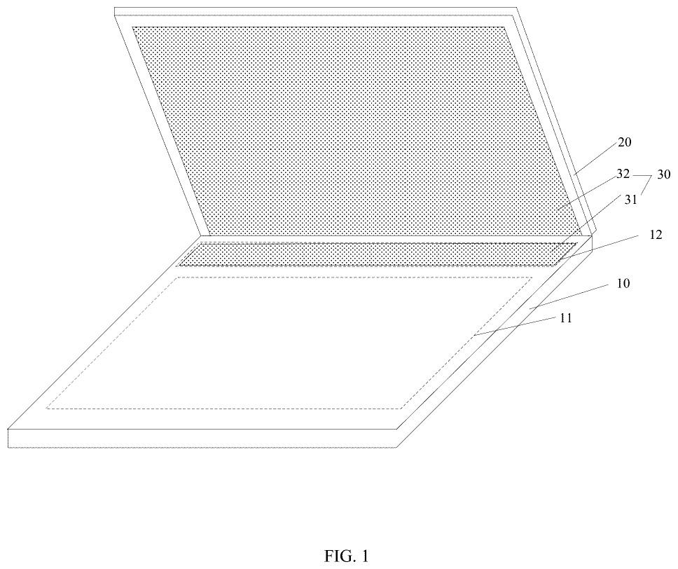

Thus, embodiments of the present disclosure provide an electronic device. As shown in FIG. 1, the electronic device includes a first body 10, a second body 20, and a display assembly 30. The second body 20 can rotate relative to the first body 10. An end of the display assembly 30 is fixedly connected to an end of the second body 20 away from the first body 10. Thus, at least a part of a display content of the display assembly 30 can be displayed on the second body 20. The first body 10 includes a first area 11 and a second area 12. The first area 11 is an input area for information input of the electronic device. In some embodiments, the second area 12 is different from the first area 11. The display area of the display assembly 30 includes a first display area 31 within the first body 10. The first display area 31 can be visible to a user through the second area 12.

In some embodiments, the display assembly 30 also includes a second display area 32 exposed outside the first body 10. The second display area 32 is arranged on the second body 20. In some embodiments, surface C of the electronic device can include the first area and the second area. Surface B of the electronic device can include the second display area.

Thus, in some embodiments, the display area of the display assembly can be displayed not only on the second body but also on the first body. Thus, the display assembly can be used differently and adjusted according to user needs to improve user experience.

In some embodiments, based on the above, the electronic device can include a rotation shaft apparatus. The rotation shaft apparatus can rotatably connect the first body and the second body to allow the second body to rotate relative to the first body.

In some embodiments of the present disclosure, the second body can include a fixed housing. An end of the fixed housing close to the rotation shaft apparatus can be fixedly connected to the rotation shaft apparatus, and an end of the fixed housing away from the rotation shaft apparatus can move in a direction perpendicular to the rotation shaft relative to the rotation shaft apparatus in a plane where the second body. Thus, an area of the display assembly located on the second body can be adjustable.

Based on the above, in embodiments of the present disclosure, the second area can switch between a transparent state and a non-transparent state. Thus, the first body can display a part of the display content of the display assembly or not display the display content of the display assembly. Then, the user can perform adjustments according to the application needs to improve the user experience. For example, when the first display area needs to be seen by the user through the second area, the second area can be in a transparent state. When the first display area does not need to be seen by the user through the second area, or the second area does not include a display area, the second area can be in a non-transparent state.

Based on the above, in embodiments of the present disclosure, the display assembly can slide relative to the first body. Thus, the user can adjust the display area of the display assembly on the second body according to the application needs of the user to improve the user experience. In some embodiments, the display assembly can be a flexible display screen. Thus, the display assembly can be bent at any position of the display assembly to ensure that a part of the display assembly is on the second body, and a part of the display assembly is on the first body, which does not impact the rotation of the second body relative to the first body.

In embodiments of the present disclosure, the display assembly and the first body can have a first relative position and a second relative position. In the first relative position, a part of the display area of the display assembly can be arranged on the first body, and a part of the display area can be arranged on the second body. Then, when the second area is in the transparent state, the first display area can be visible to the user through the second area. In the second relative position, the second area can be in the non-transparent state.

Based on the above, in embodiments of the present disclosure, in the second relative position, the entire display area of the display assembly can be arranged on the second body, which is not limited by the present disclosure and is determined according to actual needs.

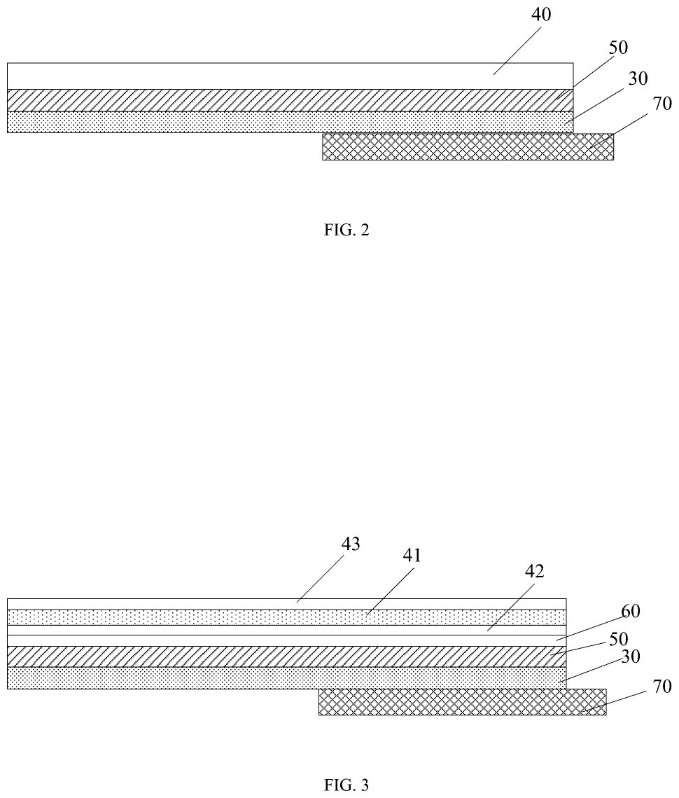

Based on the above, in embodiments of the present disclosure, as shown in FIG. 2, the first body includes an adjustment assembly 40. The adjustment assembly 40 can switch between a transparent state and a non-transparent state to allow the second area to switch between the transparent state and the non-transparent state. In some embodiments, as shown in FIGS. 1 and 2, when at least a part of the display assembly 30 is located within the first body 10, the adjustment assembly 40 is located between the display assembly 30 and the second area 12 of the first body 10. Thus, the electronic device can be facilitated to control whether the first display area of the display assembly 30 can be visible to the user through the second area 12 by the adjustment assembly 40.

In embodiments of the present disclosure, as shown in FIG. 3, the adjustment assembly includes a liquid crystal layer 41. The liquid crystal layer 41 can modulate light under the control of an electrical signal to switch the transparent state between the non-transparent state. Thus, the electronic device can control the liquid crystal layer 41 to modulate the light through the voltage. Thus, the second area can switch between the transparent state and the non-transparent state.

Based on the above, in embodiments of the present disclosure, as shown in FIG. 3, the adjustment assembly includes a first substrate 42 and a second substrate 43 arranged oppositely, and the liquid crystal layer 41 arranged between the first substrate 42 and the second substrate 43. In some embodiments, the liquid crystal layer 41 can be a polymer-dispersed liquid crystal layer, such as a bistable polymer-dispersed liquid crystal layer, which is not limited by the present disclosure and is determined as needed.

Based on the above, a plurality of first electrodes can be arranged on a side of the first substrate facing the second substrate, and a second electrode can be arranged on a side of the second substrate facing the first substrate. The electronic device can control the liquid crystal layer to modulate light by applying an electrical signal to the first electrode and the second electrode to realize the switching between the transparent state and the non-transparent state.

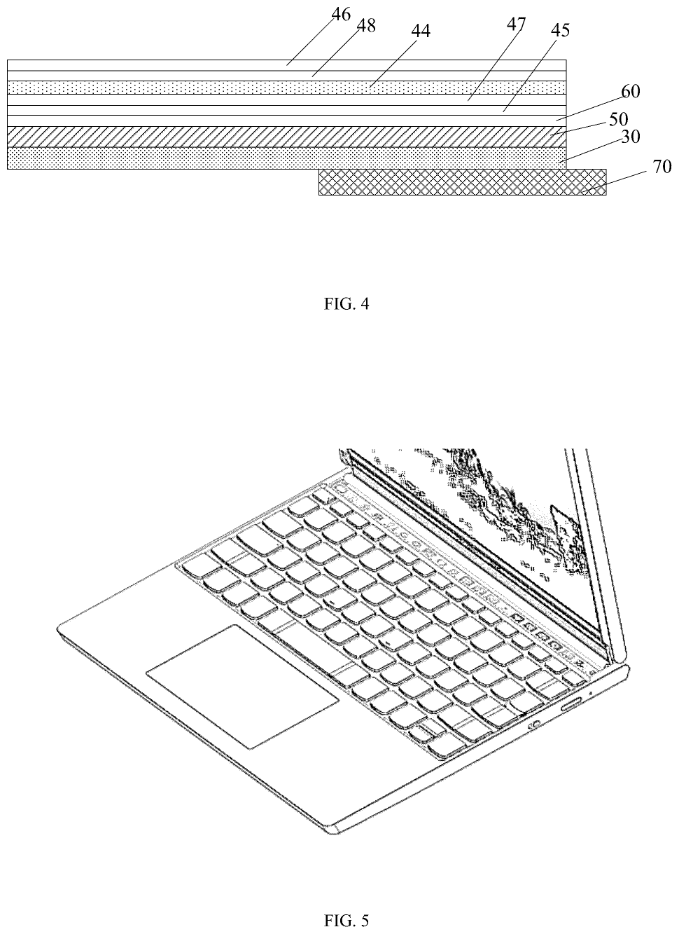

In some other embodiments of the present disclosure, as shown in FIG. 4, the adjustment assembly includes an electrochromic layer 44. The electrochromic layer 44 can be controlled by the electrical signal to modulate light to realize the switching between the transparent state and the non-transparent state. Thus, the electronic device can control the electrochromic layer 44 to modulate light through the voltage. Thus, the second area can switch between the transparent state and the non-transparent state.

Based on the above, in embodiments of the present disclosure, as shown in FIG. 4, the adjustment assembly includes a first transparent substrate 45 and a second transparent substrate 46 arranged oppositely, an electrochromic layer 44 arranged between the first transparent substrate 45 and the second transparent substrate 46, a first transparent conductive layer 47 arranged between the first transparent substrate 45 and the electrochromic layer 44, and a second transparent conductive layer 48 arranged between the second transparent substrate 46 and the electrochromic layer 44. In operation, the electronic device can apply an electrical signal to the first transparent conductive layer and the second transparent conductive layer to apply the electrical signal to an upper surface and a lower surface of the electrochromic layer to control a modulation effect of the electrochromic layer on light to realize the switching between the transparent state and the non-transparent state.

In yet some other embodiments of the present disclosure, the adjustment assembly can include a liquid crystal layer and an electrochromic layer. Thus, during the application, the user can choose to use the liquid crystal layer and/or the electrochromic layer to realize the switching between the transparent state and the non-transparent state of the second area according to the needs of the user, which is not limited.

Based on the above, in some embodiments of the present disclosure, as shown in FIGS. 2, 3, and 4, the first body includes a first input assembly 50. The first input assembly 50 can coordinate with the display content of the first display area of the display assembly 30. Thus, the electronic device can control the display content of the first display area by using the first input assembly 50.

In embodiments of the present disclosure, the first input assembly can be a touch input assembly, and the touch area of the first input assembly can be arranged in the second area. Thus, the second display area can be controlled by a touch input to improve convenience for the user. However, the present disclosure does not limit this. In other embodiments of the present disclosure, the touch area of the first input assembly can also be arranged in another area outside the second area, which is determined as needed.

Based on the above, in embodiments of the present disclosure, the first input assembly can be the touch input assembly, and when the touch area of the first input assembly is arranged in the second area, the first input assembly can be arranged between the adjustment assembly and the display assembly. Thus, the distance between the first input assembly and the second area can be reduced in a direction perpendicular to the surface of the first body, and the touch detection accuracy can be improved. Meanwhile, when the adjustment assembly is in a non-transparent state, the first input assembly may not be visible to the user through the second area.

In embodiments of the present disclosure, the first input assembly can include a touch electrode layer. The touch electrode in the touch electrode layer can be a transparent electrode. Thus, when the second area is in the transparent state, the touch electrode may not affect the first display area being visible to the user through the second area.

In embodiments of the present disclosure, as shown in FIGS. 2, 3, and 4, the first input assembly 50 is fixed to a surface of the adjustment assembly 40 facing away from the second area by optical glue 60, which is not limited by the present disclosure. In some other embodiments of the present disclosure, the first input assembly 60 can be fixedly connected to the adjustment assembly 40 in another method, which can be determined according to actual needs.

Based on the above, in embodiments of the present disclosure, the display assembly can slide relative to the first body. Thus, the display area of the display assembly on the second body can be adjustable. As shown in FIGS. 2, 3, and 4, the first body further includes a sliding assembly 70. In some embodiments, the sliding assembly 70 can be arranged within the first body and can drive the display assembly 30 to slide relative to the first body. In embodiments of the present disclosure, the sliding assembly is arranged on the side of the display assembly away from the adjustment assembly. Thus, no matter whether the second area is in the transparent state or non-transparent state, the sliding assembly cannot be visible to the user through the second area, which improves the visual experience of the electronic device.

In embodiments of the present disclosure, the sliding assembly can include a first sliding assembly. The first sliding assembly can include a motor and an encoder. The motor can drive the display assembly to slide relative to the first body, and the encoder can be configured to determine sliding information of the display assembly to facilitate the electronic device to determine the display area of the display assembly on the second body.

In another embodiment of the present disclosure, the sliding assembly includes a second sliding assembly, which includes a motor and a limit sensor. The motor drives the display assembly to slide relative to the first body. The encoder can be configured to determine the sliding information of the display assembly to facilitate the electronic device to determine the display area of the display assembly on the second body.

In yet some other embodiments of the present disclosure, the sliding assembly can include a second sliding assembly. The second sliding assembly can include a motor and a position sensor. The motor can drive the display assembly to slide relative to the first body. The position sensor can be configured to determine the sliding information of the display assembly to facilitate the electronic device to determine the display area of the display assembly on the second body.

In some other embodiments of the present disclosure, the sliding assembly can include the first sliding assembly and the second sliding assembly. Thus, the user can select the first sliding assembly according to the needs of the user to drive the display assembly to slide relative to the first body. In some other embodiments, the user can also select the second sliding assembly according to the needs of the user to drive the display assembly to slide relative to the first body. In some other embodiments, the user can use the first sliding assembly and the second sliding assembly simultaneously to drive the display assembly to slide relative to the first body, which is not limited here.

Based on the above, when the sliding assembly includes the first sliding assembly and the second sliding assembly, the first sliding assembly and the second sliding assembly can share one motor, or each has a separate motor, which is not limited here.

In embodiments of the present disclosure, the position of the first display area in the display assembly can be determined based on the sliding information of the sliding assembly driving the display assembly to slide relative to the first body. That is, based on the sliding information of the sliding assembly driving the display assembly to slide relative to the first body, the electronic device can determine the position of the first display area in the display area of the display assembly. Thus, the display position of the display content corresponding to the first display area in the display area of the display assembly can be controlled.

Based on the above, the display area of the display assembly located on the second body can be defined as the second display area. That is, in some embodiments, the display area of the display assembly can further include the second display area exposed outside the first body. In some embodiments, the first display area not only can support a touch function to input information to the electronic device in one-way, and also realize the interaction between the electronic device.

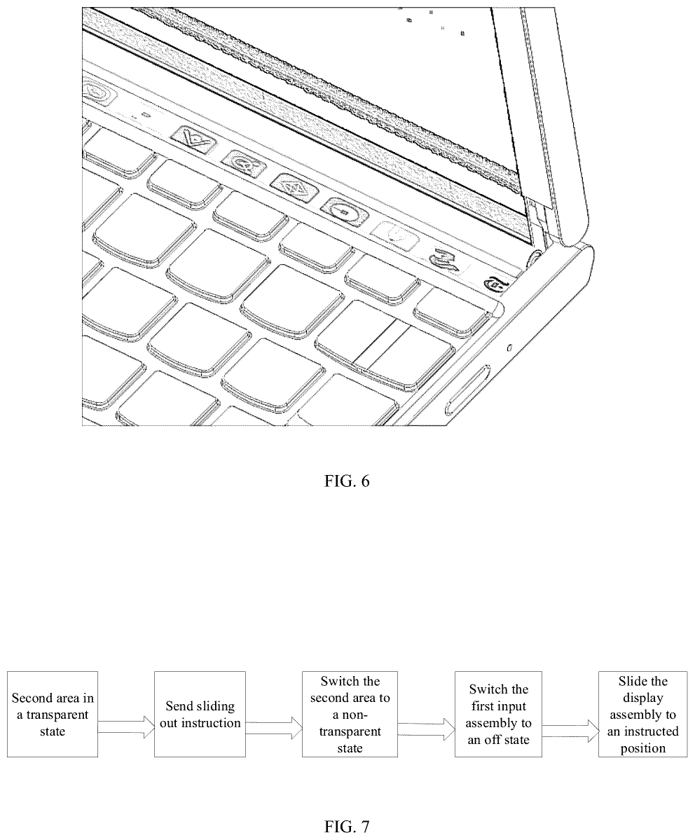

In embodiments of the present disclosure, the display content of the first display area can be determined based on the display content of the second display area. For example, in embodiments of the present disclosure, when the display content of the second display area is a collection area of a camera, the display content of the first display area can be a shortcut icon of the camera. As shown in FIGS. 5 and 6, FIG. 6 is a locally enlarged view of FIG. 5. When the display content of the second display area is a desktop, the display content of the first display area is shortcut keys, etc.

In some other embodiments of the present disclosure, the display content of the first display area can be determined based on the application running in the second display area. For instance, when the second display area displays a music-play application, the display content of the first display can be lyrics of music that is currently playing. When video-play software is the second display area application, the display content of the first display area can be a status bar for video playing.

In other embodiments of the present disclosure, the first display area can display the applications and hardware status that is currently running in the electronic device and quickly call a plurality of applications and auxiliary functions of the electronic device. In some embodiments, when the first display area can display icons of an application and/or an auxiliary function that is used by the user frequently to improve the user experience.

Based on the above, in embodiments of the present disclosure, the first display area can consistently display preset icons of applications and/or auxiliary functions that are frequently used by the user. In some other embodiments of the present disclosure, the first display area can display icons of applications and/or auxiliary functions that are currently used frequently by the user according to the preferences of the user. Thus, the icons of the applications and/or auxiliary functions displayed in the first display area can further satisfy the expectation of the user to further improve the user experience.

Based on the above, in embodiments of the present disclosure, the electronic device can further include a processing assembly. The processing assembly can be configured to determine the position of the first display area in the display assembly based on the sliding information of the sliding assembly driving the display assembly to slide relative to the first body and determine the display content of the first display area, which is not limited by the present disclosure.

The operation process of the electronic device is further described in detail according to embodiments of the present disclosure. In some embodiments, in the first relative position, the first display area of the display assembly can be arranged in the first body. The second area can be visible to the user through the first body. The second area of the display assembly can be exposed outside the first body and arranged at the second body. In the second relative position, the whole display area of the display assembly can be exposed outside the first body and arranged at the second body, which is not limited by the present disclosure. In some other embodiments, in the second relative position, the display assembly and the first body can also have other relative positions, which can be determined as needed.

In embodiments of the present disclosure, as shown in FIG. 7, the initial state of the display assembly including the display assembly and the first body having the first relative position. Then, the adjustment assembly can be in the transparent state, and the second area can be in the transparent state. The first display area of the display assembly can be visible to the user through the second area of the first body. The processing assembly can send the first control instruction of controlling the display assembly to slide out of the first body to the sliding assembly to cause the sliding assembly to drive the display assembly to slide relative to the first body until the display assembly slides to an instructed position, e.g., the display assembly and the first body having the second relative position. During the process, the processing assembly can further control the adjustment assembly to switch to the non-transparent state to cause the second area to be in the non-transparent state to control the first input assembly to switch to an off state.

Based on the above, after sending the first control instruction to the sliding assembly, the processing assembly can send the control instruction to the first input assembly and the adjustment assembly to control the adjustment assembly to switch to the non-transparent state and control the first input assembly to switch to the off state. That is, when the display assembly starts to slide relative to the first body, the adjustment assembly can switch to the non-transparent state, and the first input assembly can switch to the off state.

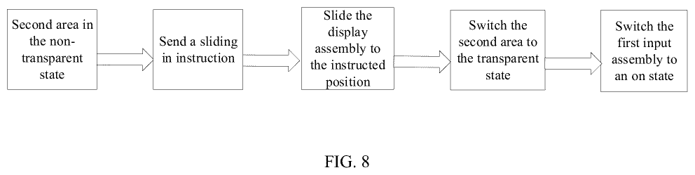

In some other embodiments of the present disclosure, as shown in FIG. 8, the initial state of the display assembly includes the display assembly and the first body having the second relative position. Then, the adjustment assembly can be in the non-transparent state, and the second area can be in the non-transparent state. The processing assembly can send a second control instruction to the sliding assembly to control the display assembly to slide into the first body to cause the sliding assembly to drive the display assembly to slide relative to the first body until the display assembly slides to the determined position, e.g., the display assembly and the first body having the first relative position. Then, the processing assembly can control the adjustment assembly to switch to the transparent state to cause the second area to be in the transparent state. The first display area of the display assembly can be visible to the user through the second area, and the first input assembly can be started to start the input function of the first input assembly.

In summary, in the electronic device of embodiments of the present disclosure, the display area of the display assembly can be displayed on the second body and the first body. Thus, the display assembly can be applied in different ways and can be adjusted according to the application needs of the user to improve user experience.

Embodiments of the present disclosure are described in a progressive manner, a parallel manner, or a combination thereof. Each embodiment focuses on the differences from other embodiments. The similar and identical parts between embodiments can be referred to each other. Since the device of embodiments of the present disclosure corresponds to the method of embodiments of the present disclosure, the description can be relatively simple, and the relevant parts can be referred to the description of the method above.

In the present disclosure, relational terms such as first and second are only used to distinguish one entity or operation from another entity or operation, and do not necessarily require or imply any such actual relationship or order between these entities or operations. Furthermore, the terms “comprise,” “include,” or any other variations thereof are intended to cover non-exclusive inclusion, so that an article or device including a series of elements not only includes those elements but may also include other elements not expressly listed, or elements inherent to such article or device. When there is no further limitation, an element defined by the phrase “comprising a . . . ” does not exclude the presence of additional identical elements in the article or device that includes the element.

The above description of embodiments of the present disclosure can enable those skilled in the art to make or use the present disclosure. Various modifications to embodiments of the present disclosure can be apparent to those skilled in the art. The general principles defined here can be realized in other embodiments of the present disclosure without departing from the spirit or scope of the present disclosure. Therefore, the present disclosure is not limited to the embodiments shown here but conforms to the widest scope consistent with the principles and novel features of the present disclosure.

What is claimed is:

1. An electronic device comprising:
a first body including a first area and a second area, the first area being an input area;
a second body rotating relative to the first body; and
a display assembly, an end of the display assembly being fixedly connected to an end of the second body away from the first body, and a display area of the display assembly including:
a first display area arranged inside the first body and being visible to a user through the second area.

2. The device according to claim 1, wherein the second area is able to be switched between a transparent state and a non-transparent state.

3. The device according to claim 2, wherein:
the display assembly slides relative to the first body;
the display assembly and the first body have a first relative position and a second relative position;
in the first relative position, the second area is in the transparent state, and the first display area is visible to the user through the second area; and
in the second relative position, the second area is in the non-transparent state.

4. The device according to claim 2, wherein the first body includes:
an adjustment assembly configured to switch between a transparent state and a non-transparent state to cause the second area to switch between the transparent state and the non-transparent state; and
the adjustment assembly includes at least one of a liquid crystal layer or an electrochromic layer.

5. The device according to claim 1, wherein the first body includes:
a first input assembly cooperating with a display content of the first display area of the display assembly.

6. The device according to claim 5, wherein a touch area of the first input assembly is arranged in at second area.

7. The device according to claim 1, wherein:
the display assembly is able to slide relative to the first body; and
the first body includes a sliding assembly arranged inside the first body and driving the display assembly to slide relative to the first body.

8. The device according to claim 7, wherein the sliding assembly includes at least one of:
a first sliding assembly including:
a motor configured to drive the display assembly to slide relative to the first body; and
an encoder configured to determine sliding information of the display assembly; and
a second sliding assembly including:
a motor configured to drive the display assembly to slide relative to the first body; and
a position sensor configured to determine the sliding information of the display assembly.

9. The device according to claim 7, wherein a position of the first display area in the display assembly is determined based on the sliding information of the sliding assembly driving the display assembly to slide relative to the first body.

10. The device according to claim 1, wherein the display area of the display assembly further includes:
a second display area exposed outside the first body, the display content of the first display area being determined based on a display content of the second display area.
